(19) United States
(12) Patent Application Publication
(10) Pub. No.: US 2005/0047690 A1
(43) Pub. Date: Mar. 3, 2005

(54) Bearing assembly with fluid circuit for delivery of lubricating fluid between bearing surfaces

(75) Inventors: Bahram Keramati, Schenectady, NY (US); Anthony Holmes Furman, Scotia, NY (US); Kendall Roger Swenson, Erie, PA (US); Daniel Edward Loringer, Erie, PA (US)

Correspondence Address: GENERAL ELECTRIC COMPANY;GLOBAL RESEARCH, PATENT DOCKET RM., BLDG. K1-4A59, PO BOX 8, SCHENECTADY, NY, 12301, US

(73) Assignee: General Electric Company

(21) Appl. No.: 10/649,429

(22) Filed: Aug. 27, 2003

(51) Int. Cl. F16C 33/16; F16C 33/10; F16C 5/00; F16N 1/00; F16C 1/24; F16C 3/14

(52) U.S. Cl. 384/368

(57) ABSTRACT

An integral thrust/journal bearing assembly, e.g., useable in a turbocharger is provided. The assembly includes a journal bearing configured to operate at a first mechanical load. The assembly further includes a thrust bearing including a thrust bearing face. The thrust bearing may be configured to operate at a second mechanical load different than the first mechanical load. A fluid circuit that includes parallel branches is provided within the integral bearing assembly for delivering parallel flows of lubricating fluid to the thrust bearing face and the journal bearing.

### FIELD OF THE INVENTION

The present invention is generally related to bearings, and, more particularly, to a fluid circuit and techniques for delivery of lubricating fluid between bearing surfaces of an integral thrust/journal bearing assembly.

### BACKGROUND OF THE INVENTION

The high speeds and/or pressure ratios that, for example, may be required for state-of-the-art turbocharger applications could result in excessive metal temperatures of rotating components in a turbocharger, such as a thrust bearing. For example, temperatures exceeding the material design limits have been measured on the thrust bearing at high turbo speeds.

One problem in bearing applications is the high heat that may be generated between rotating bearing surfaces at high loads. This problem becomes even more challenging in cases where slight misalignments can lead to an uneven load distribution between a thrust collar and the thrust bearing surfaces. This may result in poor lubrication and cooling of the bearing surfaces, and may eventually lead to failure of the bearing.

A flow of fluid may be desirable between the load carrying surfaces, with the expectation that this flow will form a thin lubricating film between the surfaces. However, in cases of imperfect alignment, manufacturing non-uniformity, or both, the distribution of the lubricating and cooling flow could well be substantially uneven among the thrust pads that may be used by the bearing. This could lead to uneven heat generation (e.g., hot spots) due to poor lubrication (e.g., dry spots), and, once again lead to a premature failure of the bearing.

### BRIEF DESCRIPTION OF THE INVENTION

Generally, the present invention fulfills the foregoing needs by providing in one aspect thereof an integral thrust/journal bearing assembly comprising a journal bearing configured to operate at a first mechanical load. The assembly further comprises a thrust bearing including a thrust bearing face. The thrust bearing may be configured to operate at a second mechanical load different than the first mechanical load. A fluid circuit that comprises parallel branches is provided within the integral bearing assembly for delivering parallel flows of lubricating fluid to the thrust bearing face and the journal bearing.

The present invention further fulfills the foregoing needs by providing in another aspect thereof a turbocharger comprising a turbocharger casing. A rotatable shaft may be supported by a bearing system comprising at least one journal bearing at opposite ends of the shaft. The bearing system further comprises at least one thrust bearing including a thrust bearing face. A fluid circuit is constructed within the bearing system and includes parallel branches for delivering parallel flows of lubricating fluid to the thrust bearing face and each journal bearing. Each parallel flow of lubricating fluid may be selected to appropriately meet bearing cooling requirements in view of different mechanical loads to which each bearing may be subjected.

In yet another aspect thereof, the present invention provides a method for retrofitting an integral thrust/journal bearing assembly. The bearing assembly includes a first path within the assembly for delivering lubricating fluid to a journal bearing. The method allows modifying the integral thrust/journal bearing assembly by providing a second path within the integral bearing assembly in parallel with the first path to deliver lubricating fluid to the thrust bearing.

### BRIEF DESCRIPTION OF THE DRAWINGS

These and other advantages of the invention will be more apparent from the following description in view of the drawings that show:

FIG. 1 is a cutaway view of an exemplary turbocharger that may benefit from an improved fluid circuit embodying aspects of the present invention for delivering lubricating fluid to bearing surfaces.

FIG. 2 is a schematic representation of an exemplary fluid circuit embodying aspects of the present invention.

FIG. 3 illustrates a perspective view of a turbine casing defining a bore for receiving a bearing assembly and including openings for passing lubricating fluid from a fluid feed plenum built within the turbocharger casing.

FIG. 4 illustrates a perspective view of bearing assembly mounted in the bore of FIG. 3 and having a thrust bearing face including openings for receiving lubricating fluid thereon.

FIG. 5 illustrates a perspective view of another embodiment of a bearing having fluid circuit for delivering lubricating fluid to a thrust bearing face, wherein the outer diameter of the bearing includes a built-in fluid plenum in communication with openings on the thrust bearing face for delivering lubricating fluid to such a face.

FIG. 6 illustrates some of the openings on the thrust bearing face of FIG. 5.

FIG. 7 illustrates an embodiment including restrictors for diverting lubricating fluid from a lightly loaded component to a thrust bearing embodying aspects of the present invention.

FIG. 8 shows a perspective view of a thrust bearing face illustrating two exemplary arrays of grooves for enhancing the flow of lubricating fluid on the thrust bearing face.

FIG. 9 illustrates a plot of some exemplary operational parameters of a bearing system relative to exemplary turbo speeds using a prior art design.

FIG. 10 illustrates a plot of the operational parameters of FIG. 9 using a fluid circuit embodying aspects of the present invention.

### DETAILED DESCRIPTION OF THE INVENTION

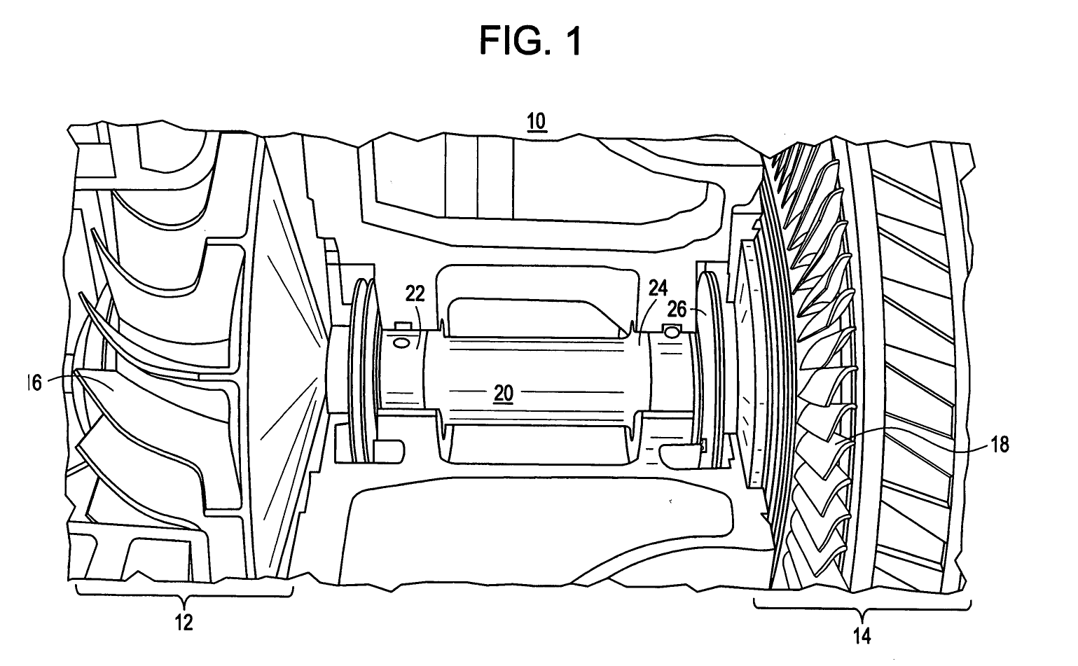

FIG. 1 shows a cutaway view of an exemplary turbocharger 10 that may benefit from the teachings of the present invention. Turbocharger 10 generally comprises respective compressor and turbine stages 12 and 14 including a compressor wheel 16 and a turbine wheel 18 coupled through a rotatable shaft 20. Shaft 20 may be supported by a bearing system that, in one exemplary embodiment, may include a journal bearing 22 at one end thereof (e.g., near compressor stage 12), and a bearing assembly at an opposite end of the shaft (e.g., near turbine stage 14). The bearing assembly may integrate a journal bearing 24 and a thrust bearing 26. The bearing system is configured to provide both radial support (through the journal bearings) and axial support (through the thrust bearing) to shaft 20 in a manner well understood by those skilled in the art.

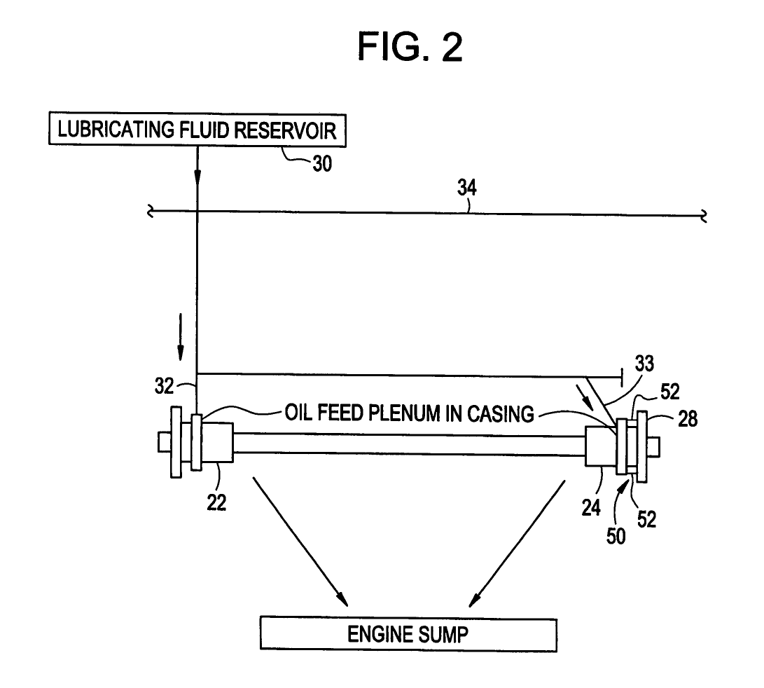

In operation, the shaft 20 may be supported in a film of lubricating fluid by the journal and thrust bearings. In one related design, improved by aspects of the present invention as discussed below, the lubricating fluid, as shown in FIG. 2, may be fed from a reservoir 30 through a parallel circuit comprising at least two branches 32 and 33 in a casing 34 of the turbocharger to the journal bearings 22 and 24, respectively. Prior to the present invention, lubricating fluid to a thrust bearing face 28 has been provided from fluid that has already circulated through the journal bearings 22 and 24. Measurements have indicated that the fluid pressure provided to the thrust bearing face 28 in this related design may be typically less than 10 psig, and the fluid temperature may be approximately 30° F. to 40° F. hotter than the supply temperature to the turbocharger.

In one exemplary application, the thrust bearing is typically the most highly loaded bearing in the turbocharger. However, in the above-mentioned related design, the thrust bearing may receive the least amount of lubricating fluid relative to other bearing components therein, e.g., the journal bearings. Just forcing additional flow of lubricating fluid to the turbocharger through the parallel circuit may be somewhat ineffective in reducing thrust face metal temperatures since a large portion of any added flow may be consumed by journal bearings 22 and 24, which may be already sufficiently cooled.

The present inventors have innovatively recognized that through an additional fluid circuit 50, such as may comprise one or more parallel lubricating fluid feed passages combined with corresponding orifices or openings that may be directly disposed on the thrust bearing face, one may achieve lower temperatures in the thrust bearing. In one exemplary embodiment, strategically disposed parallel fluid feed passages within the bearing assembly may be optionally combined with fluid flow restrictors relative to the journal bearing feeds to divert a sufficient amount of lubricant flow to the thrust face of the bearing to maintain appropriate temperatures at relatively high loads while preserving overall turbocharger fluid requirements.

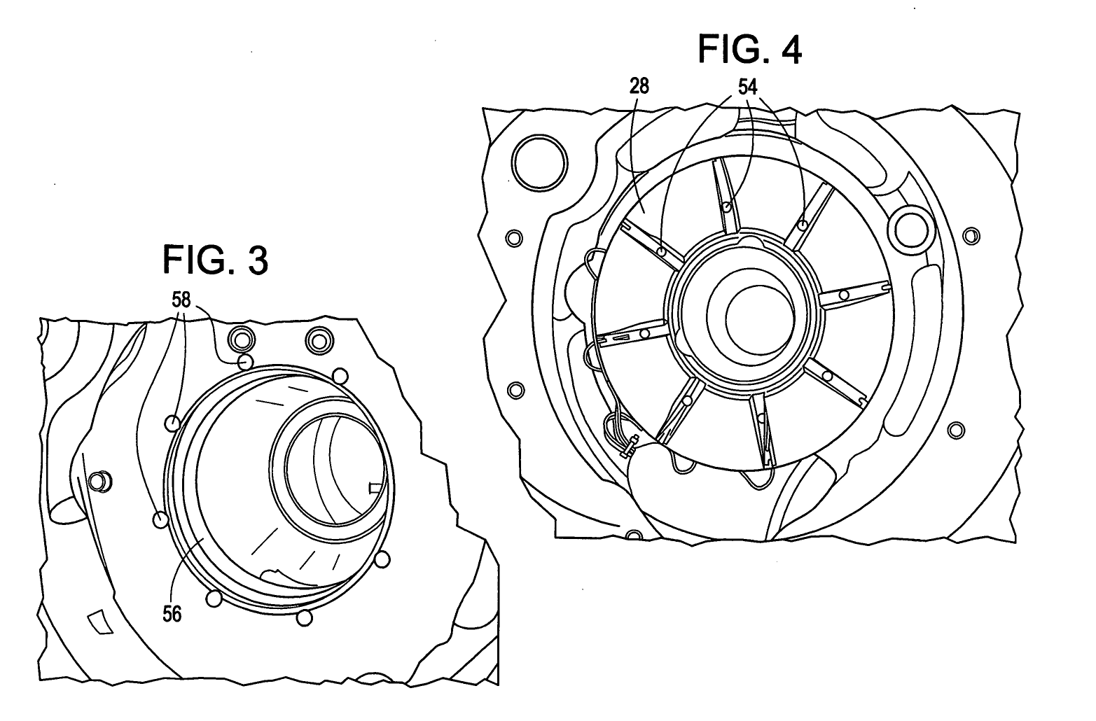

More specifically, fluid circuit 50 may comprise one or more passageways 52 (FIG. 2) to directly feed the lubricating fluid, e.g., fresh, cool, pressurized oil, to the thrust face for improved load capacity and lower bearing temperatures. In one exemplary embodiment, the fluid may be brought through one or more openings 54 (FIG. 4) constructed in the thrust bearing face 28. The openings in the thrust bearing face 28 may be arranged to have fluid communication (e.g., intersect) with a fluid feed plenum 56 (FIG. 3) through one or more openings 58 in the casing of the turbocharger. The fluid pressure in the plenum should be sufficiently high to ensure a positive supply of lubricating fluid to the thrust face. The openings 54 should be sized to provide an adequate supply of lubricating fluid to each thrust pad in the thrust bearing for lubrication and cooling purposes while maintaining sufficient pressure drop to ensure relatively even distribution through each opening.

Thus, in accordance with aspects of the present invention, one has the ability to provide essentially fresh cool lubricating fluid directly to the thrust face rather than relying on lubricating fluid being fed inconsistently down the journals and eventually onto the thrust face. FIG. 3 in part shows the casing in the turbocharger that supports the bearing assembly (the bearing assembly is actually not mounted in the bore defined by the casing shown in FIG. 3). This allows visualization of the fluid feed plenum 56, such as may be formed by a groove in the casing that supplies lubricating fluid to the bearing system. The openings 58 communicate directly with fluid feed plenum 56 in the casing. In addition, the openings 58 are disposed to be in alignment with the openings 54 through the thrust bearing face.

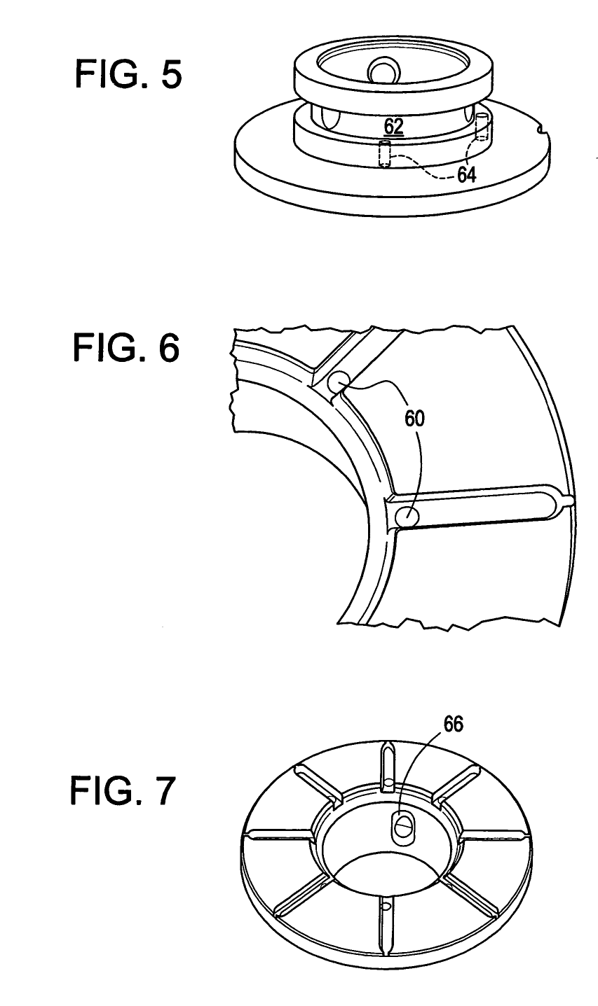

In another exemplary embodiment, one way to directly bring fresh lubricating fluid to the thrust bearing face through openings 60 (FIG. 6) may be to construct a groove 62 (FIG. 5) circumferentially extending along the outer diameter (OD) of the bearing itself in lieu of constructing holes (e.g., drilling, machining, etc.) through the casing of the turbocharger, as shown in FIG. 3. In this embodiment, there may be axially extending passageways (represented by dashed lines 64) configured to extend beneath the thrust bearing face and in fluid communication with the groove 62 to receive the fluid that accumulates within that groove. The axially extending passageways 64 may terminate in the respective exit openings 60 (FIG. 6) that allow exit to the fresh lubricating fluid directly out to the thrust face. This embodiment may be convenient in the sense that one need not make holes in the casing of the turbocharger. This may allow designing a bearing retrofit kit for field-deployed turbochargers without having to do any machining or drilling work on the casing.

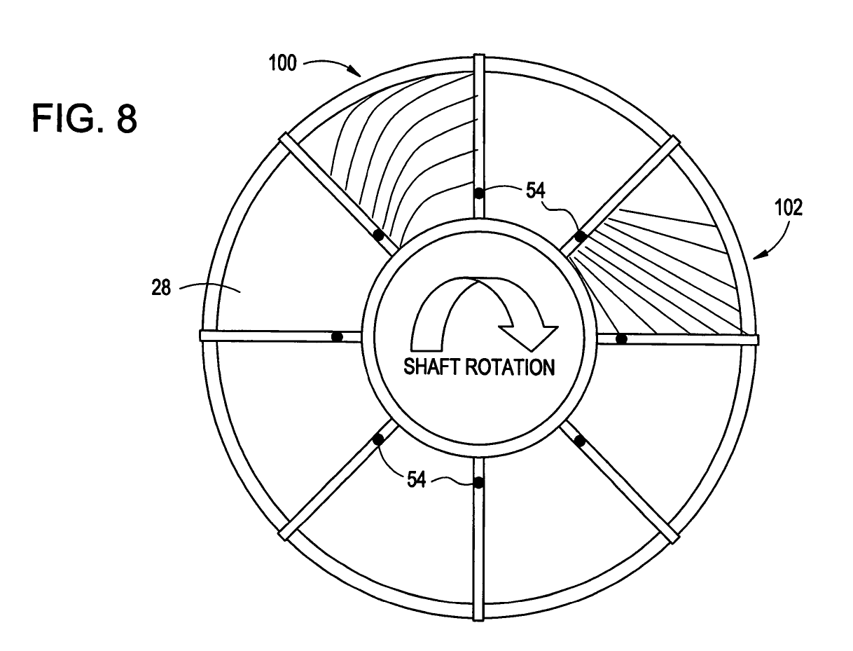

In one exemplary embodiment, a fluid restrictor 66 (FIG. 7) may be configured to restrict the flow of lubricating fluid to the compressor journal feeds by making smaller openings (or partly closing any existing openings in the inner diameter of the bearing) to restrict the amount of fluid that one may pump to the compressor journal bearing. Typically, this journal bearing operates at a relatively light load compared to the turbine bearing assembly, and thus one may not need as much lubricating fluid, as may be desirable for the turbine bearing assembly. In a related design, because of running clearances one may pump a substantial amount of fluid to the compressor bearing. That is, pumping a large amount of fluid not needed by the compressor bearing. In accordance with aspects of the present invention, one may prefer diverting fluid to the turbine end, and more particularly to the thrust bearing where the loads are commonly the highest. Thus, each respective flow of lubricating fluid may have a magnitude selected to appropriately meet bearing lubricating and cooling requirements in view of the different mechanical loads of the bearing components therein. For example, the journal bearings may be configured to operate at a first mechanical load and the thrust bearing may be configured to operate at a second mechanical load different (e.g., relatively higher) than the first mechanical load.

In yet another aspect of the present invention, as shown in FIG. 8, one may provide one or more arrays of fluid delivery channels, (e.g., channel arrays 100 and 102) grooved or otherwise constructed on the surface of the thrust bearing face to enhance or facilitate flow and/or distribution of lubricant over the entire face of the thrust bearing. By way of example, the array of channels may comprise grooves machined into the thrust bearing pads, and/or into the surface of a mating thrust collar.

The array of channels machined into the surface of the thrust pad and/or the corresponding mating collar may collectively provide a sufficiently large channel for the flow of the lubricant and ensure that lubricant fluid flow will reliably occur regardless of operational conditions and/or manufacturing tolerances. The array of channels may be configured in such a way to allow sufficient flow so that any variations in the fluid film among the pads will not be a significant source of cooling variation.

The presence of flow channels on the surface of the bearing pads (and/or mating collar) is expected to provide an overall improvement for the overall flow and distribution of the lubricant fluid. The exact shape and depth of the array of channels may vary based on the specific requirements of any given application. For example, channel array 100 may comprise a spiral pattern comprising relatively shallow grooves. Channel array 102 may comprise a generally rectilinear pattern configured to distribute the lubricating fluid to a region of the thrust bearing face that may comprise a relatively high load region. That is, a region that could otherwise result in a hot spot in the absence of the channel array. The cross-section of each groove may be configured in various shapes, circular, elliptical, square, etc.

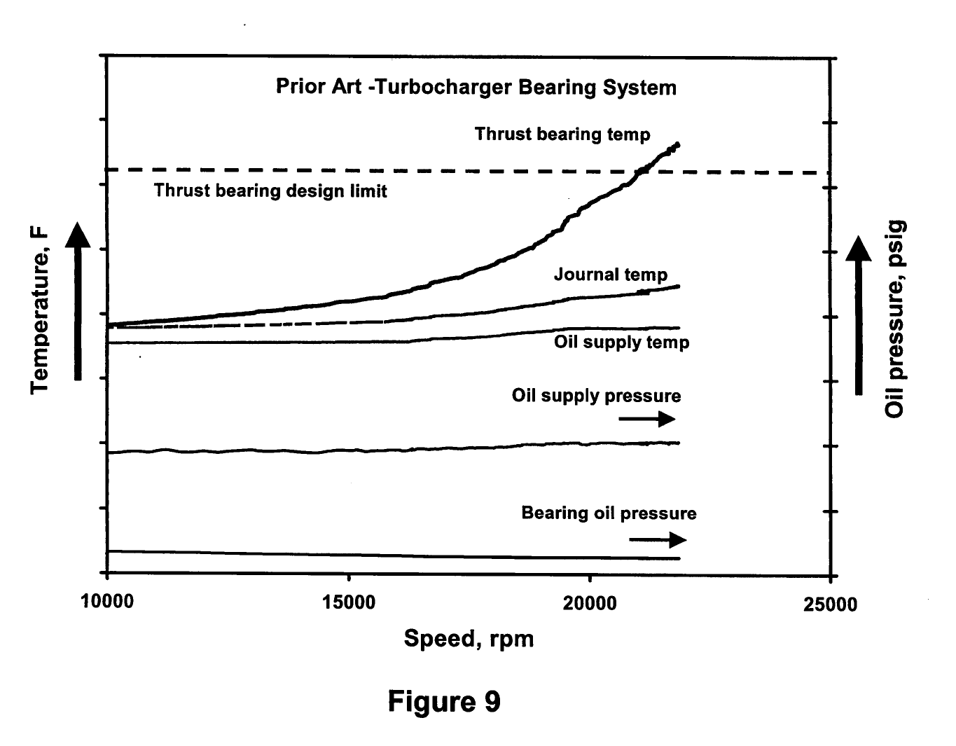

FIG. 9 illustrates a plot of some exemplary operational parameters of a bearing system relative to exemplary turbo speeds using a prior art design. It will be appreciated that as turbo speed increases, thrust bearing temperatures also increase. FIG. 9 shows average thrust bearing temperatures exceeding the material design limits for a turbocharger that is not even up to full speed. By way of comparison, the journal bearing temperatures may be on the order of about ½ of the thrust bearing temperatures. Oil temperature to the turbocharger essentially corresponds to the engine oil temperature. Even though one starts with about 100 psi at the external supply, there is only approximately 10 psi oil pressure at the turbine bearing by the time the lubricating fluid is delivered. Thus, this prior art design unnecessarily diverts a substantial amount of oil out to the compressor bearing.

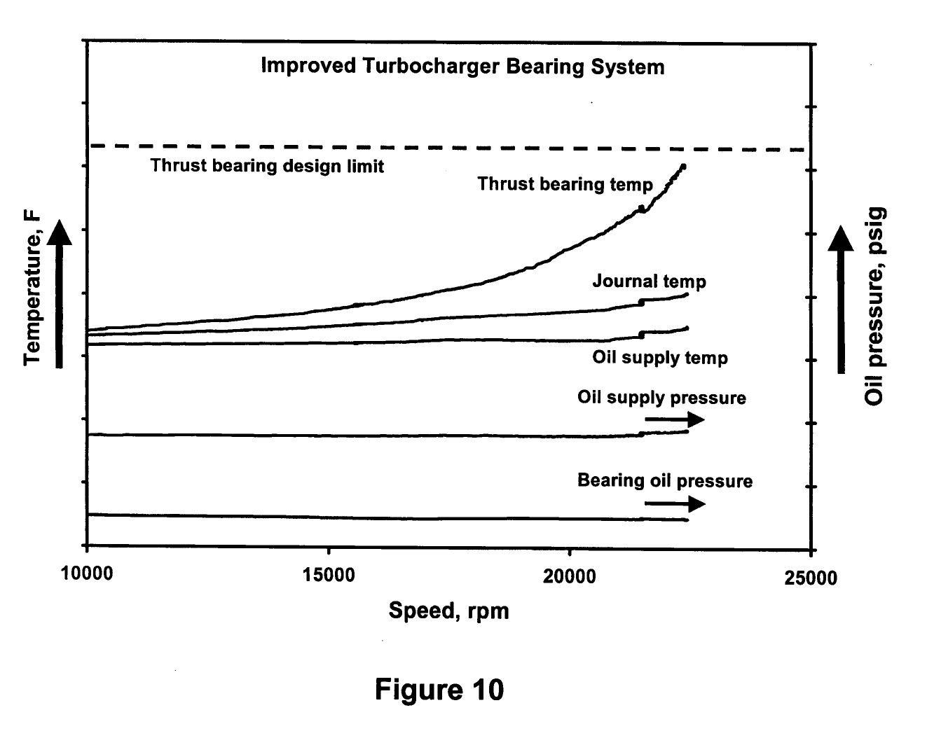

FIG. 10 illustrates a plot of the operational parameters of FIG. 9 using a fluid circuit embodying aspects of the present invention. FIG. 10 illustrates that the maximum thrust bearing temperature at a higher turbo RPM is approximately 40 to 50 degrees lower than the prior art results shown in FIG. 9. In addition, to reflect extreme operational conditions, inlet oil temperature was raised by approximately 15° F. Thus, the testing conditions corresponding to the results plotted in FIG. 10, actually reflect a relatively hotter inlet oil to the turbocharger, which normally would mean hotter bearings, and a higher turbo speed, which once again would normally mean hotter bearings, yet the thrust bearing is running at least 40 to 50 degrees cooler with a fluid circuit embodying aspects of the present invention.

While the preferred embodiments of the present invention have been shown and described herein, it will be obvious that such embodiments are provided by way of example only. Numerous variations, changes and substitutions will occur to those of skill in the art without departing from the invention herein. Accordingly, it is intended that the invention be limited only by the spirit and scope of the appended claims.

Parts List for GE Docket 131959

Part Number Name

10 turbocharger
12 compressor stages
14 turbine stages
16 compressor wheel
18 turbine wheel
20 rotatable shaft
22, 24 journal bearings
26 thrust bearing
28 thrust bearing face
30 reservoir
32, 33 parallel circuit comprising at least two branches
34 casing
50 fluid circuit
52 passageways
54 one or more openings in the thrust bearing face
56 fluid feed plenum
58 one or more openings in the casing
60 exit openings
62 groove
64 axially extending passageways
66 fluid restrictor
100,102 channel arrays

1. An integral thrust/journal bearing assembly comprising:
a journal bearing configured to operate at a first mechanical load, and a thrust bearing including a thrust bearing face, the thrust bearing configured to operate at a second mechanical load different than the first mechanical load; and
a fluid circuit comprising parallel branches within the integral bearing assembly for delivering parallel flows of lubricating fluid to the thrust bearing face and the journal bearing.

2. The integral bearing assembly of claim 1 wherein each parallel flow of lubricating fluid is selected to appropriately meet bearing cooling requirements in view of the different mechanical loads to which each bearing is subjected.

3. The integral assembly of claim 1 mountable in a bore defined by a casing, wherein the fluid circuit comprises at least one passageway in fluid communication with a fluid plenum in the casing.

4. The integral bearing assembly of claim 1 wherein the fluid circuit comprises at least one passageway in fluid communication with a fluid plenum built in the bearing assembly.

5. The integral bearing assembly of claim 4 wherein the fluid plenum comprises a groove extending along an outer diameter of the bearing assembly.

6. The integral bearing assembly of claim 5 wherein the bearing assembly comprises a passageway in fluid communication with the built-in fluid plenum for passing lubricating fluid from the fluid plenum to the thrust bearing face through at least one opening in said face.

7. The integral bearing assembly of claim 1 further comprising at least one array of channels on the thrust bearing face for distributing lubricating fluid over said face.

8. The integral bearing assembly of claim 7 wherein the array of channels comprises a spiral-like pattern.

9. The integral bearing assembly of claim 7 wherein the array of channel comprises a generally rectilinear pattern for directing lubricating fluid to a hot spot region on said face.

10. The integral bearing assembly claim 1 further comprising at least one array of channels on a bearing collar in correspondence with the thrust bearing face for distributing lubricating fluid over said face.

11. The integral bearing assembly of claim 10 wherein the array of channels comprises a spiral-like pattern.

12. The integral bearing assembly of claim 10 wherein the array of channel comprises a generally rectilinear pattern for directing lubricating fluid to a highly loaded region on said face.

13. The integral bearing assembly of claim 1 wherein the second mechanical load is higher relative to the first mechanical load and wherein the bearing assembly further comprises at least one fluid restrictor connected to divert a higher amount of lubricating fluid to the thrust bearing.

14. A turbocharger comprising:
a turbocharger casing;
a rotatable shaft supported by a bearing system comprising at least one journal bearing at opposite ends of the shaft, the bearing system further comprising at least one thrust bearing including a thrust bearing face; and
a fluid circuit comprising parallel branches for delivering parallel flows of lubricating fluid to the thrust bearing face and each journal bearing, each parallel flow of lubricating fluid selected to appropriately meet bearing cooling requirements in view of different mechanical loads to which each bearing may be subjected.

15. The turbocharger of claim 14 wherein the thrust bearing is mountable in a bore defined by the turbocharger casing, wherein the fluid circuit comprises at least one passageway in fluid communication with a fluid plenum in the turbocharger casing.

16. The turbocharger of claim 15 wherein the turbocharger casing defines at least one opening in fluid communication with the fluid plenum in the casing for passing lubricating fluid from the fluid plenum to the thrust bearing face through at least one opening in said face.

17. The turbocharger of claim 16 wherein the at least one opening in the turbocharger casing is in alignment with the at least one opening in the thrust bearing face.

18. The turbocharger of claim 14 wherein the fluid circuit comprises at least one passageway in fluid communication with a fluid plenum built in the thrust bearing.

19. The turbocharger of claim 18 wherein the fluid plenum comprises a groove extending along an outer diameter of the thrust bearing.

20. The turbocharger of claim 19 wherein the thrust bearing comprises a passageway in fluid communication with the built-in fluid plenum for passing lubricating fluid from the fluid plenum to the thrust bearing face through at least one opening in said face.

21. The turbocharger of claim 14 comprising at least one array of channels for distributing lubricating fluid over the thrust bearing face, the array disposed on at least one of the following structures: a bearing collar in correspondence with the thrust bearing face, and the thrust bearing face.

22. The turbocharger of claim 21 wherein the array of channels comprises a spiral-like pattern.

23. The turbocharger of claim 21 wherein the array of channel comprises a generally rectilinear pattern for directing lubricating fluid to a region of said face comprising a hot spot.

24. The turbocharger of claim 14 wherein the mechanical load of the thrust bearing is higher relative to the mechanical load of each journal bearing and further comprising at least one fluid restrictor connected to divert a higher amount of lubricating fluid to the thrust bearing.

25. A method for retrofitting an integral thrust/journal bearing assembly, the bearing assembly including a first path within the assembly for delivering lubricating fluid to a journal bearing, the method comprising:
modifying the integral thrust/journal bearing assembly by providing a second path within the integral bearing assembly in parallel with the first path to deliver lubricating fluid to the thrust bearing.

26. The method of claim 25 further comprising restricting a flow of lubricating fluid in the first path to divert a higher flow of lubricating fluid through the second path to the thrust bearing.
